(19) United States
(12) Patent Application Publication
(10) Pub. No.: US 2025/0282693 A1
(43) Pub. Date: Sep. 11, 2025

(54) AMENDMENT TO FACILITATE BIOREMEDIATION OF CONTAMINATED MATERIAL

(71) Applicant: Charger Environmental, LLC, Midland, TX (US)

(72) Inventor: Ronny Crawford, Midland, TX (US)

(73) Assignee: Charger Environmental, LLC, Midland, TX (US)

(21) Appl. No.: 18/598,636

(22) Filed: Mar. 7, 2024

(51) Int. Cl. C05G 3/80; B09C 1/08; C05C 1/00; C05G 3/50; C09K 17/44; C09K 17/50

(52) U.S. Cl. CPC C05G 3/80; B09C 1/08; C05C 1/00; C05G 3/50; C09K 17/44; C09K 17/50; B09C 2101/00

(57) ABSTRACT

A method for amending contaminated soil includes tailoring a surfactant-based soil amendment to the targeted contaminant. If the contaminant is a hydrocarbon, the soil is amended with a composition of a surfactant (about 5% by weight), cellulose (about 45% by weight), an oxidizer (about 40% by weight), and a nitrogen fertilizer (about 10% by weight). If the contaminant is a chloride, the soil is amended with a composition of a surfactant (about 15% by weight), gypsum (about 75% by weight), and a nitrogen fertilizer (about 10% by weight).

### BACKGROUND AND SUMMARY

This invention pertains generally to compositions for amending material to address contaminants in the material. More specifically, the invention is directed to amendment compositions and processes that encourage the growth and function of microbes in the contaminated material to encourage microbial degradation of contaminants such as hydrocarbons and chlorides.

Contamination of material is often an unfortunate byproduct of industrial practices. For example, hydrocarbon or chloride chemicals are common contaminants found in soil and water reservoirs. Decontamination of the contaminated material may proceed by microbial degradation of the contaminant. The addition of engineered or non-native microbes to facilitate this biodegradation can be expensive and can itself impose environmental risks. Accordingly, there is a need for technology to facilitate bioremediation of the contaminated material by nurturing naturally occurring microbes to facilitate in-situ microbial degradation of the contaminants by the native microbes.

In an aspect of the invention, a method of treating contaminated soil by encouraging degradation of the contaminant by native microbes includes applying a surfactant-based soil amendment tailored to the targeted contaminant. For hydrocarbon contaminants, the amendment is a composition of a surfactant, cellulose, an oxidizer, and nitrogen fertilizer. For chloride contaminants, the amendment is a composition of a surfactant, gypsum, and nitrogen fertilizer. Preferably, the surfactant is a gemini surfactant or biosurfactant, the cellulose is ground corn husk, the oxidizer is sodium percarbonate, and the nitrogen fertilizer is ammonium nitrate.

In another aspect of the invention, a composition for treating a contaminated material comprises: 2.5-7.5% (5±2.5%) surfactant by weight, 35-55% (45±10%) cellulose by weight, 35-45% (40±10%) oxidizer by weight, and 5-15% (10±5%) nitrogen fertilizer by weight. Preferably, the composition comprises (all by weight): 5±1% o-dodecylbenzenesulfonate surfactant, 45±1% corn husk, 40±1% sodium percarbonate, and 10±1% ammonium nitrate. In another aspect of the invention, the composition comprises (all by weight): 5±1% o-dodecylbenzenesulfonate surfactant, 40±1% corn husk, 40±1% sodium percarbonate, 10±1% ammonium nitrate, and 5±1% iron sulfate.

In another aspect of the invention, a composition for treating a contaminated material comprises: 5-25% (15±10%) surfactant by weight, 65-85% (75±10%) gypsum by weight, and 5-15% (10±5%) nitrogen fertilizer by weight. Preferably, the composition comprises (all by weight): 15±5% o-dodecylbenzenesulfonate surfactant, 75±5% gypsum, and 10±1% ammonium nitrate.

### BRIEF DESCRIPTION OF THE DRAWINGS

These and other features, aspects, and advantages of the present invention will become better understood with reference to the following description, appended claims, and accompanying drawings where:

FIG. 1 is a flowchart illustrating an exemplary method of amending soil to encourage biodegradation of hydrocarbons by naturally occurring microbes.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

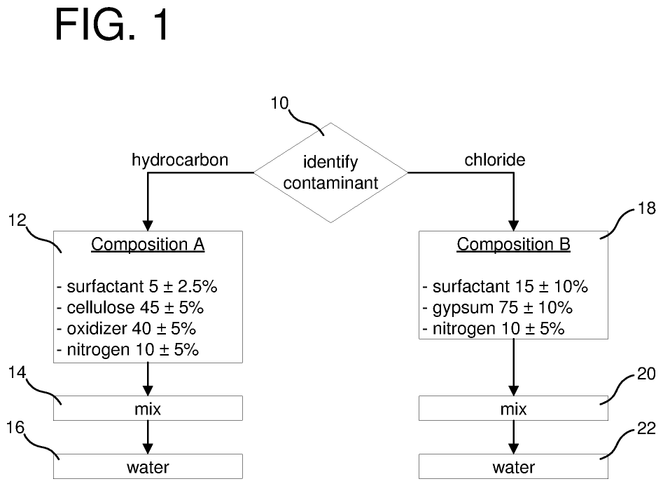

FIG. 1 illustrates an exemplary process for amending soil to address soil contamination. An environmental technician determines 10 what contaminant to address in the soil through, e.g., measurement, history, or supposition. If targeting a hydrocarbon contaminant, the technician provides 12 a hydrocarbon-targeting composition comprising a surfactant, cellulose, oxidizer, and nitrogen fertilizer. If targeting a chloride contaminant, the technician provides 18 a chloride-targeting composition comprising a surfactant, gypsum, and nitrogen fertilizer. The technician may provide both the hydrocarbon-targeting composition and chloride-targeting composition in this process if, e.g., both hydrocarbon and chloride contaminants are to be addressed.

In the hydrocarbon-targeting composition, the surfactant serves to stabilize the contaminant, separate it from the soil matrix, and increase opportunities for interaction between the contaminant and microbes in the soil. The surfactant may also change the hydrophobicity of microbial cell surfaces to enhance interaction between the contaminant and the microbes. Most surfactants will serve this purpose, but gemini surfactants and biosurfactants are preferred. In one preferred embodiment, the surfactant is C₁₈H₂₉NaO₃S (often referred to as sodium o-dodecylbenzenesulfonate and SDBS). The hydrocarbon-targeting composition includes 2.5-7.5% surfactant by weight, with a preferred range of 5±1 percent by weight.

The cellulose serves to improve the morphological parameters and improve the biochemical indices of the soil matrix to encourage growth of naturally occurring microbes. It also serves to improve soil stability and strength, to help neutralize the soil, to improve soil washing through absorption of water and liquid hydrocarbons, and to improve activation of oxidizer and fertilizers through retention of water. Various sources of cellulose will serve this purpose (e.g., saw dust, cotton seed, mesquite beans, peat moss, manure) but a particularly advantageous embodiment utilizes ground corn husk. The hydrocarbon-targeting composition includes 40-50% cellulose by weight, with a preferred range of 45±1 percent by weight.

The oxidizer serves to encourage growth of naturally occurring microbes, neutralize acidized solutions and soil toxicity, and promote rapid and sustained in-situ oxidation of organic compounds. The oxidizer produces oxygen to enhance microbial biodegradation of the contaminant(s). A variety of oxidizers will serve this purpose (e.g., hydrogen peroxide, sodium bicarbonate, ozone, permanganate, persulfate) but a particularly advantageous embodiment utilizes Na₂H₃CO₆ (sodium percarbonate). The hydrocarbon-targeting composition includes 35-45% oxidizer by weight, with a preferred range of 40±1 percent by weight.

The nitrogen fertilizer serves to supplement the oxidizer and provide nitrogen for the microbial degradation of the contaminant. A variety of nitrogen fertilizers will serve this purpose but a particularly advantageous embodiment utilizes NH₄NO₃ (ammonium nitrate). The hydrocarbon-targeting composition includes 5-15% nitrogen fertilizer by weight, with a preferred range of 10±1 percent by weight.

In an advantageous variant of the hydrocarbon-targeting composition, an amount of cellulose may be replaced with FeSO₄ (ferrous sulfate) so that the composition includes 2.5-7.5% FeSO₄ by weight. with a preferred range of 5±1 percent by weight.

Once the hydrocarbon-contaminant microbial-remediation composition is provided, it is then mixed 14 into the contaminated soil in an amount of 0.5±0.2 pounds per square foot of contaminated area (˜2.4±1.0 kg/m²). Then, water is added 16 to the area in the amount of 2.0±1.0 gallons per square foot (˜81.5±40.7 l/m²).

In the chloride-targeting composition, the surfactant and nitrogen serve the same purposes of those described above with respect to the composition targeting hydrocarbon contaminants. The gypsum (CaSO₄2H₂O) removes sodium by interaction between sulfate ions and sodium ions. The negativity charged sodium ions attract positively charged sodium ions forming sodium sulfate which is highly leachable within soils. The chloride-targeting composition includes 5-25% surfactant by weight, with a preferred range of 15±5% by weight, 65-85%, gypsum by weight, with a preferred range of 75±5 percent by weight, and 5-15 percent nitrogen fertilizer by weight, with a preferred range of 10±1 percent by weight.

Once the chloride-contaminant microbial-remediation composition is provided, it is then mixed 20 into the contaminated soil in an amount of 0.5±0.2 pounds per square foot of contaminated area (˜2.4±1.0 kg/m²). Then, water is added 22 to the area in the amount of 7.5±2.5 gallons per square foot (˜300.6±101.9 l/m²).

While the foregoing description is directed to the preferred embodiments of the invention, other and further embodiments of the invention will be apparent to those skilled in the art and may be made without departing from the basic scope of the invention. For example, the compositions are applicable to other contaminated areas and materials, such as contaminated liquids in aquifers. And features described with reference to one embodiment may be combined with other embodiments, even if not explicitly stated above, without departing from the scope of the invention. The scope of the invention is defined by the claims which follow.

The invention claimed is:

1. A method for treating an area of contaminated soil, the method comprising:
(a) determining the targeted contaminant;
(b) if the targeted contaminant is a hydrocarbon:
(i) providing a composition in an amount of 0.5±0.2 pounds per square foot of the area of contaminated soil, the composition comprising: a surfactant in an amount of 2.5-7.5 percent by weight, cellulose in an amount of 40-50 percent by weight, an oxidizer in an amount of 35-45 percent by weight, and a nitrogen fertilizer in an amount of 5-15 percent by weight;
(ii) mixing the composition into the area of contaminated soil; and
(iii) spraying water in an amount of 2±1 gallons per square foot of the area of contaminated soil
(c) if the targeted contaminant is a chloride:
(i) providing a composition in an amount of 0.5±0.2 pounds per square foot of the area of contaminated soil, the composition comprising: a surfactant in an amount of 5-25 percent by weight, gypsum in an amount of 65-85 percent by weight, and a nitrogen fertilizer in an amount of 5-15 percent by weight;
(ii) mixing the composition into the area of contaminated soil; and
(iii) spraying water in an amount of 7.5±2.5 gallons per square foot of the area of contaminated soil.

2. A composition for treating a contaminated material, the composition comprising:
(a) a surfactant in an amount of 5±2.5 percent by weight;
(b) cellulose in an amount of 45±15 percent by weight;
(c) an oxidizer in an amount of 40±5 percent by weight; and
(d) a nitrogen fertilizer in an amount of 10±5 percent by weight.

3. The composition of claim 2 wherein the cellulose is ground corn husk.

4. The composition of claim 2 wherein the oxidizer is sodium percarbonate.

5. The composition of claim 2 wherein the nitrogen fertilizer is ammonium nitrate.

6. The composition of claim 2 wherein the surfactant is sodium o-dodecylbenzenesulfonate.

7. The composition of claim 2 wherein the surfactant includes at least one of the group consisting of gemini surfactants and biosurfactants.

8. The composition of claim 2 wherein:
(a) the amount of surfactant is 5±1 percent by weight;
(b) the amount of cellulose is 45±1 percent by weight;
(c) the amount of oxidizer is 40±1 percent by weight; and
(d) the amount of nitrogen fertilizer is 10±1 percent by weight.

9. The composition of claim 2 further comprising ferrous sulfate, wherein:
(a) the amount of surfactant is 5±2.5 percent by weight;
(b) the amount of cellulose is 40±5 percent by weight;
(c) the amount of oxidizer is 40±5 percent by weight;
(d) the amount of nitrogen fertilizer is 10±5 percent by weight; and
(e) the amount of ferrous sulfate is 5±2.5 percent by weight.

10. The composition of claim 9 wherein:
(a) the amount of surfactant is 5±1 percent by weight;
(b) the amount of cellulose is 40±1 percent by weight;
(c) the amount of oxidizer is 40±1 percent by weight;
(d) the amount of nitrogen fertilizer is 10±1 percent by weight; and
(e) the amount of ferrous sulfate is 5±1 percent by weight.

11. A composition for treating a contaminated material, the composition comprising:
(a) a surfactant in an amount of 15±10 percent by weight
(b) gypsum in an amount of 75±10 percent by weight; and
(c) a nitrogen fertilizer in an amount of 10±5 percent by weight.

12. The composition of claim 11 wherein the nitrogen fertilizer is ammonium nitrate.

13. The composition of claim 11 wherein the surfactant is sodium o-dodecylbenzenesulfonate.

14. The composition of claim 11 wherein the surfactant includes at least one of the group consisting of gemini surfactants and biosurfactants.

15. The composition of claim 11 wherein:
(a) the amount of surfactant is 15±5 percent by weight;
(b) the amount of gypsum is 75±5 percent by weight; and
(c) the amount of nitrogen fertilizer is 10±1 percent by weight.
